(19) United States
(12) Patent Application Publication
(10) Pub. No.: US 2026/0259524 A1
(43) Pub. Date: Sep. 3, 2026

(54) PROCESS CARTRIDGE

(71) Applicant: ZHUHAI DINGHUI TECHNOLOGY CO., LTD., Zhuhai (CN)

(72) Inventor: Jinshi FAN, Zhuhai (CN)

(73) Assignee: ZHUHAI DINGHUI TECHNOLOGY CO., LTD., Zhuhai (CN)

(21) Appl. No.: 19/437,581

(22) Filed: Dec. 31, 2025

(30) Foreign Application Priority Data
Jan. 3, 2025 (CN) 202520017001.0

(51) Int. Cl. G03G 15/00; G03G 21/16; G03G 21/18

(52) U.S. Cl. CPC G03G 15/757; G03G 21/1647; G03G 21/1814; G03G 21/185; G03G 21/186; G03G 21/1867; G03G 2221/1657

(57) ABSTRACT

A process cartridge detachably mountable in an image forming apparatus includes: a housing, including a first housing for containing toner and a second housing connected to the first housing; a rotating member, including a developing roller rotatably disposed in the first housing and a photosensitive drum rotatably disposed in the second housing, wherein the photosensitive drum has a rotation axis extending along a longitudinal direction; a driving force receiving assembly, located at a drive end of the housing and having the same rotation axis as the photosensitive drum; a bearing plate, for supporting the driving force receiving assembly, wherein the driving force receiving member is exposed outward from the bearing plate; and a cartridge-side positioned portion, provided separately from the bearing plate and protruding along the longitudinal direction in a direction away from a non-drive end.

### CROSS-REFERENCE TO RELATED APPLICATIONS

This application claims priority to Chinese Patent Application No. 202520017001.0, filed on Jan. 3, 2025, the content of which is incorporated herein by reference in its entirety.

### TECHNICAL FIELD

The present application relates to the field of electrophotographic image forming, and particularly to a process cartridge detachably mountable in an electrophotographic image forming apparatus.

### BACKGROUND

A process cartridge is a consumable detachably mounted in an electrophotographic image forming apparatus (hereinafter referred to as the “apparatus”). The process cartridge is provided with at least one rotating member therein. The rotating member is used for agitating toner stored in the process cartridge, or forming an electrostatic latent image on a surface thereof, or carrying toner to supply the toner to a component for forming the electrostatic latent image, etc.

To drive the rotating member to rotate, the process cartridge is further provided with a driving force receiving member for receiving a driving force from a driving force output member in the apparatus. During the process of the driving force output member outputting driving force to the driving force receiving member, especially at the moment when the driving force output member outputs the driving force to the driving force receiving member, the process cartridge may shake due to receiving a sudden large driving force. Therefore, how to improve the positioning effect of the process cartridge in the image forming apparatus is a problem that needs to be considered.

### SUMMARY

The present application provides a process cartridge with the following technical solution, so that the process cartridge can be stably positioned in the image forming apparatus. The specific solution is as follows.

A process cartridge, detachably mountable in an image forming apparatus, includes: a housing, including a first housing for containing toner and a second housing connected to the first housing; a rotating member, including a developing roller rotatably disposed in the first housing and a photosensitive drum rotatably disposed in the second housing, wherein the photosensitive drum is arranged opposite to the developing roller, and the photosensitive drum has a rotation axis extending along a longitudinal direction; a driving force receiving assembly, located at a drive end of the housing, wherein the driving force receiving assembly includes a driving force receiving member having the same rotation axis as the photosensitive drum, the driving force receiving member is configured to receive a driving force from the image forming apparatus; a bearing plate, configured to support the driving force receiving assembly, wherein the driving force receiving member is exposed outward from the bearing plate; and a cartridge-side positioned portion, provided separately from the bearing plate and protruding along the longitudinal direction in a direction away from a non-drive end, wherein, when viewed along the longitudinal direction, the cartridge-side positioned portion surrounds a part of the driving force receiving member. This avoids tilting caused by uneven force on the bearing plate, which is beneficial for precise positioning of the process cartridge mounting.

In some embodiments, the process cartridge includes an end cover disposed on the same side as the driving force receiving assembly, wherein the cartridge-side positioned portion is disposed on at least one of the end cover, the first housing, and the second housing. The instantaneous apparatus acting force received by the bearing plate is alleviated, the stress on the cartridge-side positioned portion is reduced, and breakage is less likely to occur.

In some embodiments, the cartridge-side positioned portion is configured as a plate member having an arcuate profile surrounding the rotation axis of the driving force receiving member. The plate member having an arcuate profile can avoid interference between the driving force receiving member and the apparatus.

In some embodiments, at least one of the end cover, the first housing, and the second housing is detachably coupled to the cartridge-side positioned portion. A user can replace a matching cartridge-side positioned portion according to the structure inside the image forming apparatus, so that the process cartridge will have broader universality.

In some embodiments, the image forming apparatus is provided with an apparatus-side positioning portion, and the process cartridge is positioned in the image forming apparatus by the cartridge-side positioned portion abutting against the apparatus-side positioning portion.

In some embodiments, the bearing plate includes a plate body and a through hole penetrating the plate body, and the driving force receiving member passes through the through hole to be exposed outside the plate body. The driving force receiving member passes through the through hole to mesh with a driving force output member to receive driving force.

In some embodiments, when viewed along the longitudinal direction, at least a part of the cartridge-side positioned portion overlaps with the plate body, which makes the structure of the process cartridge more compact and facilitates miniaturization.

In some embodiments, the bearing plate includes an extension portion extending from the plate body in a direction of the non-drive end, and when viewed along the longitudinal direction, the extension portion is located radially outward of a driving force transmission portion of the driving force receiving member, wherein a distance from the extension portion to the rotation axis of the photosensitive drum is greater than a radius of the photosensitive drum. The extension portion can shield at least a part of the driving force transmission portion, so that the driving force transmission portion can be protected by the extension portion.

In some embodiments, the image forming apparatus is provided with a driving force output member engaged with the driving force receiving member, the driving force output member includes an apparatus-side rotation shaft and a force output protrusion protruding from the apparatus-side rotation shaft; the process cartridge includes a control mechanism at least for forcing the driving force receiving member to rotate by a certain angle; wherein, the driving force receiving member includes a plurality of driving force receiving portions, and along a rotation direction of the driving force receiving member, an entry opening allowing the driving force output member to enter is formed between two adjacent driving force receiving portions; during mounting and dismounting of the process cartridge, the control mechanism is configured to actuate the driving force receiving member to rotate to a position where the entry opening is opposite to the apparatus-side rotation shaft. This avoids interference between the driving force receiving member for receiving the apparatus driving force and the apparatus, which is beneficial for smooth mounting of the process cartridge.

In some embodiments, the control mechanism includes an acting portion for contacting the driving force receiving member, and through a friction force generated between the acting portion and the driving force receiving member, the driving force receiving member is driven to rotate by a certain angle, simplifying the structure of the driving force receiving assembly.

In some embodiments, the non-drive end of the housing is provided with a chip electrically contacting the image forming apparatus, the chip includes an electrical contact surface for communication connection with the image forming apparatus, the chip is located at an upper portion of the housing, and the electrical contact surface is configured to face upward relative to the housing.

In some embodiments, the process cartridge is mounted into and dismounted from the image forming apparatus along a lateral direction, a side of the process cartridge provided with the photosensitive drum and the developing roller is a lower side, a side opposite to the lower side is an upper side, and a direction intersecting with the longitudinal direction and the lateral direction is an up-down direction; along the up-down direction, the electrical contact surface is configured to face a direction away from the photosensitive drum.

In some embodiments, the image forming apparatus is provided with a guide rail, and the process cartridge includes a positioning member guided by the guide rail, the positioning member protruding outward from the housing longitudinally; wherein, along the lateral direction, the positioning member includes a front positioning member and a rear positioning member which are spaced apart from each other.

In some embodiments, the cartridge-side positioned portion includes a positioning connection portion fixedly connected to at least one of the end cover, the first housing, and the second housing; the bearing plate includes a bearing connection portion fixedly connected to at least one of the end cover, the first housing, and the second housing; wherein on a plane perpendicular to the longitudinal direction, an orthographic projection of at least one of the bearing connection portion and the positioning connection portion has at least a part that lies within a maximum area bounded by the front positioning member, the rear positioning member, and the driving force receiving member. The process cartridge can be precisely positioned by the apparatus and can also achieve stable electrical connection with the apparatus.

In some embodiments, the maximum area is a closed area bounded collectively by: (i) outer contours of the front positioning member, the rear positioning member, and the driving force receiving member; and (ii) straight line segments connecting the front positioning member, the rear positioning member, and the driving force receiving member.

In some embodiments, the line segments include: (i) a first line segment connecting the front positioning member and the rear positioning member; (ii) a second line segment connecting the rear positioning member and the driving force receiving member; and (iii) a third line segment connecting the driving force receiving member and the front positioning member.

In some embodiments, the non-drive end of the housing is provided with a power receiving portion for electrically contacting the image forming apparatus to receive electric power; on the projection plane perpendicular to the longitudinal direction, at least a part of the projection of the power receiving portion is located within the maximum area. The structural layout of the power receiving portion, the chip, and the chip electrical contact surface, the cartridge-side positioned portion, etc., in the process cartridge is conducive to maintaining a stable working state of the process cartridge.

In some embodiments, the cartridge-side positioned portion is provided with a first terminal point and a second terminal point; wherein an angle α between a fourth line segment connecting the first terminal point to the rotation axis of the photosensitive drum and a fifth line segment connecting the second terminal point to the rotation axis satisfies: 60°<α<180°. The cartridge-side positioned portion within the range of the angle α can be guided by the apparatus-side positioning portion, and the process cartridge is easier to detach from the image forming apparatus during the removal process.

In some embodiments, at least one of the positioning connection portion and the bearing connection portion is fixedly disposed on the second housing, and at least one of the positioning connection portion and the bearing connection portion is configured as a through hole.

In some embodiments, along the longitudinal direction, a distance from a terminal end of the cartridge-side positioned portion to the non-drive end is not less than a distance from a terminal end of the driving force receiving member to the non-drive end. Along the longitudinal direction, the cartridge-side positioned portion can also avoid interference between the driving force receiving member and the apparatus.

According to one of the technical solutions disclosed in the present application, by providing the cartridge-side positioned portion of the process cartridge separately from the bearing plate, the momentary excessive acting force received by the bearing plate from the apparatus can be effectively alleviated, avoiding tilting or fracture caused by excessive stress on the bearing plate which would reduce the mounting positioning stability of the process cartridge, which is conducive to maintaining a stable working state of the process cartridge.

### BRIEF DESCRIPTION OF THE DRAWINGS

FIG. 1 is a schematic diagram of the mounting process of a process cartridge involved in the present application.

FIG. 2 is a perspective view of a driving force receiving assembly involved in Embodiment 1 of the present application being mounted on a photosensitive drum.

FIG. 3A is an exploded view of some components of the driving force receiving assembly involved in Embodiment 1 of the present application.

FIG. 3B is a perspective view of the driving force receiving assembly involved in Embodiment 1 of the present application, with a hub hidden.

FIG. 4A is a cross-sectional view of the driving force receiving assembly and a driving force output member involved in Embodiment 1 of the present application before they start to engage, taken along a plane passing through a rotation axis of the driving force receiving assembly.

FIG. 4B is a cross-sectional view of the driving force receiving assembly and the driving force output member involved in Embodiment 1 of the present application after engagement, taken along a plane passing through the rotation axis of the driving force receiving assembly.

FIG. 5 is a perspective view of a driving force receiving assembly involved in Embodiment 2 of the present application, with a hub hidden.

FIG. 6 is a perspective view of a hub in a driving force receiving assembly involved in Embodiment 3 of the present application.

FIG. 7 is a perspective view of a driving force receiving assembly involved in Embodiment 4 of the present application, with a hub hidden.

FIG. 8 is an exploded view showing an end cover separated from a housing of a process cartridge involved in Embodiment 5 of the present application,.

FIG. 9 is an exploded view showing a bearing plate separated from a housing of the process cartridge involved in a variant of Embodiment 5 of the present application.

FIG. 10 is a perspective view of a bearing plate in the process cartridge involved in a variant of Embodiment 5 of the present application.

FIG. 11 is an exploded view of a bearing plate and a driving force receiving assembly in a process cartridge involved in Embodiment 6 of the present application.

FIG. 12 is a perspective view of a bearing plate in the process cartridge involved in Embodiment 6 of the present application.

FIG. 13 is a cross-sectional view of the bearing plate and the driving force receiving assembly in the process cartridge involved in Embodiment 6 of the present application after combination, taken along a plane passing through a rotation axis of a driving force receiving member.

FIG. 14 is a perspective view of a second housing in a process cartridge involved in Embodiment 7 of the present application.

FIG. 15 is a structural schematic diagram of a process cartridge involved in Embodiment 8 of the present application.

FIG. 16 is a structural schematic diagram of a part of the process cartridge involved in Embodiment 8 of the present application, viewed along a longitudinal direction.

FIG. 17 is a structural schematic diagram of a part of the process cartridge involved in Embodiment 8 of the present application, viewed along a direction perpendicular to the longitudinal direction.

### DETAILED DESCRIPTION OF THE EMBODIMENTS

Embodiments of the present application will be described in detail below with reference to the accompanying drawings.

### Overall Structure of Process Cartridge

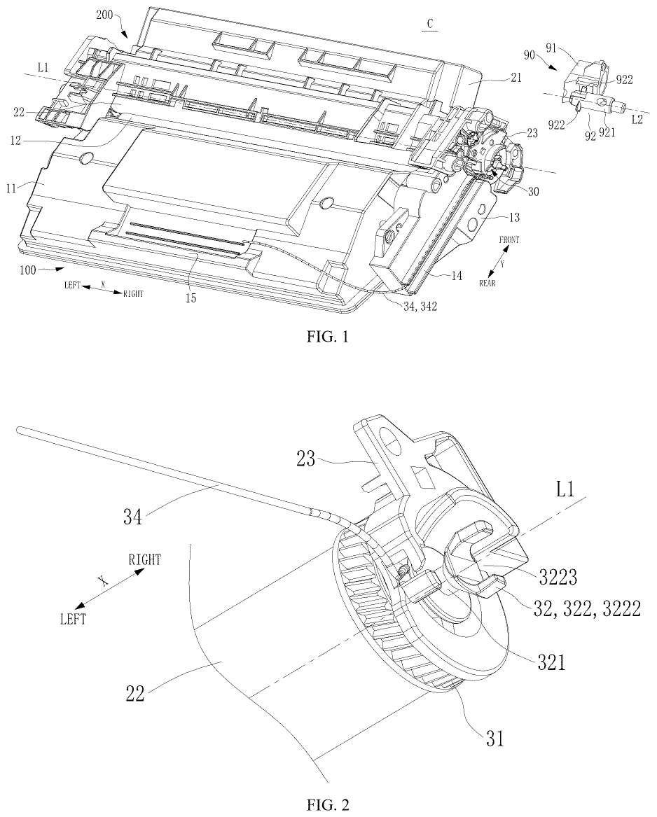

As shown in FIG. 1, a process cartridge C can be detachably mounted to an apparatus provided with an apparatus-side acting device 90. The apparatus-side acting device 90 includes an apparatus-side acting block 91 and a driving force output member 92 which are adjacent and spaced apart. The driving force output member 92 includes an apparatus-side rotation shaft 921 and a force output protrusion 922. The force output protrusion 922 protrudes from the apparatus-side rotation shaft 921. For example, two force output protrusions 922 are disposed radially opposite to each other on an outer surface of the apparatus-side rotation shaft 921.

The process cartridge C includes at least one of a first unit 100 and a second unit 200. The first unit 100 includes a first housing 11 and a developing roller 12 rotatably disposed in the first housing 11. The developing roller 12 is used for carrying toner contained in the first housing 11. The second unit 200 includes a second housing 21 and a photosensitive drum 22 rotatably disposed in the second housing 21. Therefore, the first unit 100 is also referred to as a developing unit, the first housing 11 is also referred to as a developing housing, the second unit 200 is also referred to as a drum unit, and the second housing 21 is also referred to as a drum housing. The photosensitive drum 22 and the developing roller 12 are arranged opposite to each other. When the process cartridge C performs image forming, the photosensitive drum 22 and the developing roller 12 can either contact each other or be spaced apart from each other. A surface of the photosensitive drum 22 is used to form an electrostatic latent image, and the developing roller 12 supplies toner carried on its surface to the photosensitive drum 22, so that the electrostatic latent image is developed.

Further, the process cartridge C further includes a driving force receiving assembly 30 for receiving a driving force from the apparatus. The developing roller 12 and the photosensitive drum 22 are directly or indirectly driven by the driving force receiving assembly 30 to rotate about their respective rotation axes. That is to say, the driving force receiving assembly 30 may be disposed in the first unit 100, or it may be disposed in the second unit 200.

For ease of description, a direction in which the rotation axis of the developing roller 12 or the rotation axis of the photosensitive drum 22 is located is defined as a longitudinal direction X. Along the longitudinal direction X, an end provided with the driving force receiving assembly 30 is a drive end, and an end opposite to the drive end is a non-drive end. A direction from the drive end pointing to the non-drive end is left, and the opposite is right. A direction intersecting with the longitudinal direction X is a lateral direction Y. Along the lateral direction Y, the process cartridge C is mounted forward to the apparatus and dismounted backward from the apparatus.

Hereinafter, description will be made by taking an example where the driving force receiving assembly 30 is disposed in the second unit 200 and the driving force receiving assembly 30 directly drives the photosensitive drum 22. At this time, the driving force receiving assembly 30 will be coaxial with the photosensitive drum 22, or the driving force receiving assembly 30 directly meshes with the photosensitive drum 22 to transmit the driving force.

In some embodiments, a rotation axis of the driving force receiving assembly 30 may be parallel to the rotation axis of the photosensitive drum 22.

As described above, the process cartridge C includes at least one of the first unit 100 and the second unit 200. Therefore, the process cartridge C may be simplified to include a housing and a rotating member rotatably disposed in the housing. The housing is at least one of the first housing 11 and the second housing 21, and the rotating member is at least one of the developing roller 12 and the photosensitive drum 22. The driving force receiving assembly 30 and the rotating member are collectively referred to as a rotating assembly.

It should be understood that the rotating member may also be a toner supply roller or an agitating rack rotatably disposed in the first housing 11. The agitating rack is used to agitate the toner contained in the first housing 11. The toner supply roller is in contact with the developing roller 12, and the toner supply roller is used to supply toner to the developing roller 12. The rotating member may also be a charging roller rotatably disposed in the second housing 21. The charging roller is in contact with the photosensitive drum 22 and is used to charge the surface of the photosensitive drum 22. Therefore, the rotating member should be understood as a component rotatably disposed in the housing, the component can be directly/indirectly driven by the driving force received from the driving force receiving assembly 30.

Further, the process cartridge C further includes an end cover 13, a handle 15, and a bearing plate 23. The end cover 13 is fixedly connected to the housing (first housing 11) and used to protect components (such as a gear train transmitting driving force inside the process cartridge) in the process cartridge C. The handle 15 is disposed on the housing (first housing 11). The first housing 11 and the second housing 21 may be connected via the end cover 13. A user can mount or dismount the process cartridge C by grasping the handle 15. Along the longitudinal direction X, the end cover 13 is disposed on the same side as the driving force receiving assembly 30. The bearing plate 23 is fixedly mounted on the housing (second housing 21) and used to rotatably support the driving force receiving assembly 30. The bearing plate 23 is disposed on the same side as the driving force receiving assembly 30. Along the longitudinal direction X, a part of the driving force receiving assembly 30 passes through the bearing plate 23.

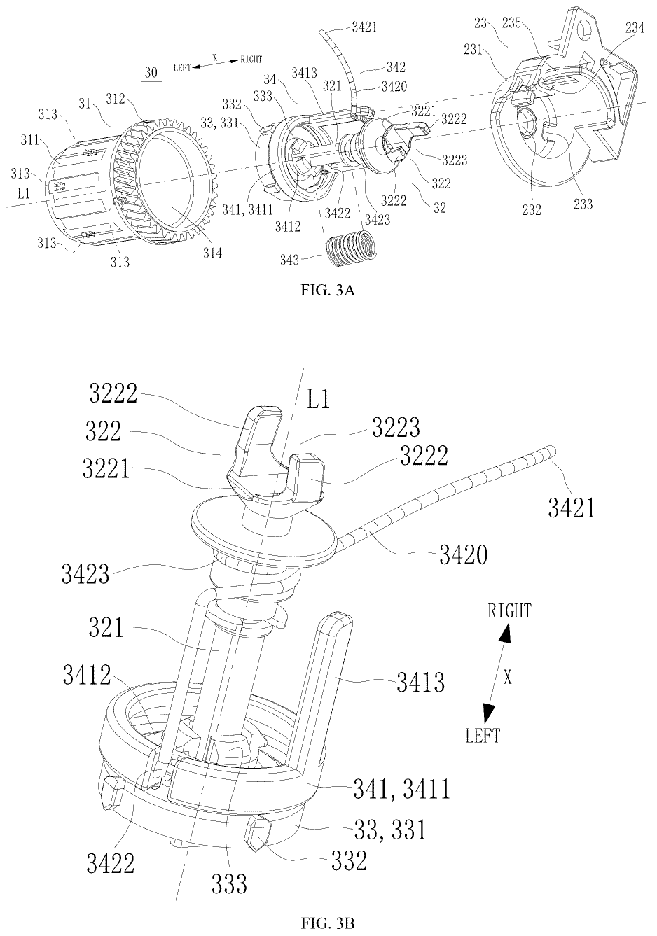

As shown in FIG. 3A, the bearing plate 23 includes a plate body 231, a through hole 232, a first positioning portion 233, and a second positioning portion 234. The bearing plate 23 is fixedly mounted on the housing (second housing 21) via the plate body 231. A driving force receiving member 32 passes through the through hole 232, so that at least a driving body 322 is exposed outside the plate body 231. That is, the driving force receiving member 32 is exposed outward from the bearing plate 23. The first positioning portion 233 is used for positioning and guiding a control member 342 described below. The second positioning portion 234 is used for positioning a force applying member (lifting member) 341 described below, so that a clutch member 33 described below can rotate relative to the lifting member 341.

### Driving Force Receiving Assembly

### Embodiment 1

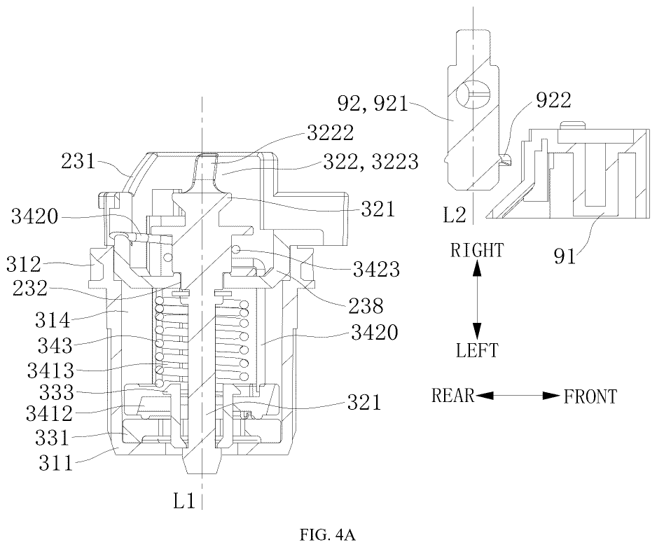

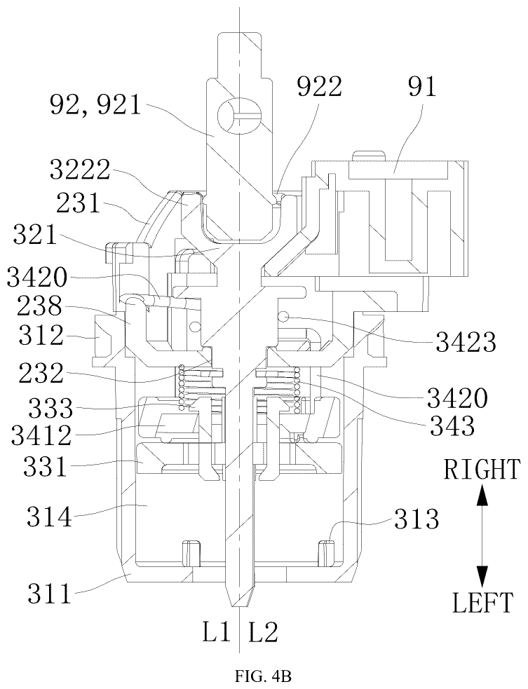

To achieve smooth mounting and dismounting of the process cartridge C in the image forming apparatus, a general process cartridge C includes a driving force receiving member 32 retractable along the rotation axis of the driving force receiving assembly 30, or the driving force receiving member 32 is configured as a freely swingable universal joint structure, to avoid interference between the driving force receiving assembly 30 for receiving the apparatus driving force and the apparatus. However, this not only increases requirements for manufacturing precision and assembly precision of the driving force receiving assembly 30, but the structure of the driving force receiving member 32/driving force receiving assembly 30 also becomes increasingly complex. The driving force receiving assembly 30 in this embodiment can effectively simplify the structure of the process cartridge while solving the interference problem. As shown in FIG. 2, FIG. 3A, FIG. 3B, FIG. 4A, and FIG. 4B, the driving force receiving assembly 30 includes a hub 31, a driving force receiving member 32, a clutch member 33, and a control mechanism 34. The driving force receiving member 32 is used to mesh with the driving force output member 92 to receive a driving force. The hub 31 is used to transmit the driving force received by the driving force receiving member 32. For example, the hub 31 directly transmits the driving force to the rotating member. The clutch member 33 is disposed between the driving force receiving member 32 and the hub 31 and is configured to be moveable between a transmission position and a disengaged position. In the transmission position, the driving force receiving member 32 and the hub 31 transmit force via the clutch member 33. In the disengaged position, the driving force receiving member 32 and the hub 31 cannot transmit force via the clutch member 33. The control mechanism 34 is used to control the transition of the clutch member 33 between the transmission position and the disengaged position.

The hub 31 is configured as a cylindrical body, including a cylinder body 311, a driving force transmission portion 312, and a driven portion 313. An activity cavity 314 is formed inside the cylinder body 311. The driven portion 313 is disposed in the activity cavity 314 and is used to receive the driving force from the clutch member 33. The driving force transmission portion 312 is used to transmit the driving force received by the driven portion 313. For example, when the driving force receiving assembly 30 is disposed coaxially with the photosensitive drum 22, the cylinder body 311 can directly transmit the driving force received by the driven portion 313 to the photosensitive drum 22, and the driving force transmission portion 312 can transmit the driving force to other components. When the driving force receiving assembly 30 is disposed non-coaxially with the photosensitive drum 22, the driving force transmission portion 312 can transmit the driving force to the photosensitive drum 22. A part of the driving force receiving member 32, at least a part of the clutch member 33, and a part of the control mechanism 34 are all located in the activity cavity 314. It can be seen that the driving force receiving assembly 30 may be configured as a whole unit independent of the rotating member, thus the driving force receiving assembly 30 has certain universality.

The driving force receiving member 32 includes a shaft body 321 and a driving body 322 connected to each other. Alternatively, the shaft body 321 and the driving body 322 may be integrally formed. The shaft body 321 is connected to the clutch member 33 in a force-transmittable manner for transmitting the driving force received by the driving body 322. Preferably, the shaft body 321 is fixedly connected to the clutch member 33, or the shaft body 321 and the clutch member 33 are snap-fitted to each other along the axial direction. Thus, the shaft body 321/driving force receiving member 32 and the clutch member 33 can move together along the longitudinal direction X. The driving body 322 includes a chassis 3221 and a plurality of driving force receiving portions 3222 disposed on the chassis 3221. The chassis 3221 is connected to the shaft body 321. Along the longitudinal direction X, the driving force receiving portions 3222 extend from the chassis 3221 in a direction away from the shaft body 321 for meshing with the force output protrusion 922 to receive driving force. Thus, the driving force receiving portions 3222 and the shaft body 321 are respectively located on two sides of the chassis 3221. At least one driving force receiving portion 3222 is provided. As shown in FIG. 3A and FIG. 3B, two driving force receiving portions 3222 are disposed opposite to each other along a radial direction of the chassis 3221. Along the rotation direction of the driving force receiving member 32, or in other words, along the circumferential direction/rotation direction of the driving force receiving member 32, an entry opening 3223 allowing the driving force output member 92/apparatus-side rotation shaft 921 to enter is formed between adjacent two driving force receiving portions 3222.

The clutch member 33 includes a first main body 331, an active portion 332, and a mating portion 333. The active portion 332 and the mating portion 333 are both disposed on the first main body 331. The first main body 331 is used to cooperate with the shaft body 321. Along the rotation direction of the driving force receiving member 32, the first main body 331 and the shaft body 321 can transmit force, or in other words, the clutch member 33 and the driving force receiving member 32 can transmit force. The active portion 332 is used to transmit driving force. The mating portion 333 is used to cooperate with the control mechanism 34. In the transmission position, along the rotation direction of the driving force receiving member 32, at least a part of the active portion 332 is opposite to/overlaps with at least a part of the driven portion 313. Thus, force transmission can be performed between the active portion 332 and the driven portion 313. In the disengaged position, along the rotation direction of the driving force receiving member 32, the active portion 332 and the driven portion 313 are not opposite/overlapping. Thus, force transmission cannot be performed between the active portion 332 and the driven portion 313. In this embodiment, the active portion 332 and the driven portion 313 are both configured as protrusions. Preferably, along the longitudinal direction X, the driven portion 313 is disposed near the left end of the cylinder body 311, and the driven portion 313 is closer to the photosensitive drum 22 than the driving force transmission portion 312.

The control mechanism 34 includes a force applying member (lifting member in this embodiment) 341, a control member 342, and a reset member 343. The lifting member 341 is simultaneously connected to the clutch member 33 and the control member 342. Specifically, the lifting member 341 includes a second main body 3411, a mated portion 3412, and a positioned portion 3413. Wherein, the mated portion 3412 and the positioned portion 3413 are both connected to or integrally formed with the second main body 3411. The mated portion 3412 is used to cooperate with the mating portion 333 disposed in the clutch member 33, so that the lifting member 341 and the clutch member 33 are mutually restricted in the longitudinal direction X. The positioned portion 3413 is configured as a protrusion protruding from the second main body 3411, specifically a protrusion extending toward the driving force receiving portion 3222, for cooperating with a second positioning portion 234 other than the control mechanism 34, to limit the rotation of the lifting member 341 along the rotation direction of the driving force receiving member 32. That is to say, the lifting member 341 and the clutch member 33 can rotate relative to each other.

The control member 342 is configured as a flexible member, used for connecting with the lifting member 341 and interacting with the driving force receiving member 32. In one implementation, the first positioning portion 233 is configured as a perforation penetrating the plate body 231 in the longitudinal direction X. The control member 342 passes through the first positioning portion 233 and is positioned. At the same time, the control member 342 can also be guided by the first positioning portion 233.

The control member 342 includes a third main body 3420, a first end portion 3421, a second end portion 3422, and an acting portion 3423. The first end portion 3421 and the second end portion 3422 are respectively located at two ends of the third main body 3420. The first end portion 3421 is used to receive an external acting force that forces the control member 342 to move. The second end portion 3422 is used to connect with the lifting member 341, so that the external acting force is transmitted to the lifting member 341. Through the cooperation of the mating portion 333 and the mated portion 3412, the clutch member 33 also moves together with the lifting member 341. The acting portion 3423 is configured to be able to move following the movement of the third main body 3420. The acting portion 3423 may be configured as a part of the third main body 3420, or as a component connected to the third main body 3420. When the external acting force is applied to the control member 342, the acting portion 3423 is driven and interacts with the driving force receiving member 32. Utilizing the friction force between the acting portion 3423 and the driving force receiving member 32, the driving force receiving member 32 is driven to rotate by a certain angle, to avoid or reduce interference between the driving force receiving member 32 and the driving force output member 92. More specifically, interference between the driving force receiving portion 3222 and the force output protrusion 922 is avoided or reduced, so that the driving force receiving member 32 and the driving force output member 92 can be engaged or disengaged more smoothly. The reset member 343 is used to force the clutch member 33 to move along the longitudinal direction X/rotation axis L1 of the driving force receiving member 32, causing the clutch member 33 to return from the transmission position to the disengaged position, or return from the disengaged position to the transmission position. The direction of the restoring force applied by the reset member 343 to the clutch member 33 is opposite to the direction of the force applied by the external acting force to the clutch member 33. In this embodiment, the external acting force is used to force the clutch member 33 to move from the transmission position to the disengaged position, and the reset member 343 is used to force the clutch member 33 to return from the disengaged position to the transmission position. Therefore, the reset member 343 is configured as an elastic member directly or indirectly contacting the clutch member 33.

In this embodiment, the acting portion 3423 is configured as a part of the third main body 3420. As shown in FIG. 3A and FIG. 3B, a part of the third main body 3420 serves as the acting portion 3423 wound on the shaft body 321 of the driving force receiving member 32. The reset member 343 is configured as a compression spring with one end contacting the lifting member 341, and the other end of the reset member 343 contacting the driving force receiving member 32.

In some embodiments, the control member 342 is configured as an elastic member. By configuring the control member 342 as a flexible member or an elastic member, the arrangement of the control member 342 in the process cartridge C does not need to be limited by the structure of the process cartridge C. Thus, the control member 342 has a higher degree of mounting freedom. Further, the control member 342 also has better compatibility and can be applied to various types of process cartridges.

In some embodiments, the control member 342 may also be configured as an elastic cord. Specifically, the acting portion 3423 is also configured as an elastic cord, the elastic acting force of the acting portion 3423 actuates the driving force receiving member 32 to rotate by a certain angle, to avoid or reduce interference between the driving force receiving member 32 and the driving force output member 92.

In some embodiments, the control member 342 may also be configured as a torsion spring.

In some embodiments, the other end of the reset member 343 may also contact the bearing plate 23.

In some embodiments, the reset member 343 may also be configured as a tension spring with one end contacting the clutch member 33. In this case, the other end of the reset member 343 will contact the cylinder body 311 or the housing.

In some embodiments, the acting portion 3423 may not need to be wound on the shaft body 321. As long as the acting portion 3423 contacts the shaft body 321, and the friction force between the two is sufficient to make the driving force receiving member 32 rotate, it is sufficient. For example, the surface of the acting portion 3423 or the surface of the shaft body 321 is configured as a rough surface, or the surface of the acting portion 3423 or the surface of the shaft body 321 is covered with a friction member such as rubber, sponge, etc., that can generate friction force.

In some embodiments, the first end portion 3421 may be directly pulled by a user's hand. That is to say, the external acting force is a pulling force applied to the control member 342 by the user's hand.

In some embodiments, the first end portion 3421 may also be connected to the handle 15. The handle 15 is configured to be movable relative to the housing. During the process of the user grasping the handle 15 to mount or dismount the process cartridge C, as the handle 15 moves, the external acting force can be applied to the first end portion 3421.

In some embodiments, the external acting force may also come from the image forming apparatus. For example, the first end portion 3421 is connected to a door cover of the image forming apparatus. During the process of opening or closing the door cover, the first end portion 3421 is pulled by the door cover.

In some embodiments, the process cartridge C is further provided with a guide portion 14 for guiding the control member 342. For example, the guide portion 14 is configured as a groove formed on the end cover 13. A part of the control member 342 is guided by the groove to control the movement trajectory of the control member 342, and also allow the external acting force to be effectively transmitted in the control member 342.

The process of mutual engagement between the driving force receiving assembly 30/driving force receiving member 32 and the driving force output member 92 is described below with reference to FIG. 4A and FIG. 4B.

As shown in FIG. 4A, before the driving force receiving assembly 30/driving force receiving member 32 and the driving force output member 92 start to engage, the clutch member 33 is in the transmission position. For the driving force receiving member 32, the position of the driving force receiving portion 3222 will be random. Therefore, along the mounting direction, two possible positional relationships may appear between the driving force receiving member 32/entry opening 3223 and the apparatus-side rotation shaft 921:

In a first position, the entry opening 3223 is not opposite to the apparatus-side rotation shaft 921, or in other words, the driving force receiving portion 3222 is opposite to the apparatus-side rotation shaft 921. At this time, for the position where the driving force receiving portion 3222 is located, refer to FIG. 4B. The driving force receiving assembly 30/driving force receiving member 32 will interfere with the driving force output member 92.

In a second position, the entry opening 3223 is opposite to the apparatus-side rotation shaft 921, or in other words, the driving force receiving portion 3222 is not opposite to the apparatus-side rotation shaft 921. As shown in FIG. 4A, the driving force receiving assembly 30/driving force receiving member 32 will not interfere with the driving force output member 92.

In the case of the above-mentioned second position, the process cartridge C can be smoothly mounted, and the driving force receiving assembly 30/driving force receiving member 32 can be smoothly engaged with the driving force output member 92.

In the case of the above-mentioned first position, the control member 342 receives an external acting force and moves. The second end portion 3422 of the control member 342 pulls the lifting member 341. Through the cooperation of the mating portion 333 and the mated portion 3412, the lifting member 341 drives the clutch member 33 to move from the transmission position to the disengaged position. At this time, the driving force receiving member 32 will be able to rotate freely, and the reset member 343 undergoes elastic deformation. As the process cartridge C is further mounted, even if the driving force receiving member 32 interferes with the driving force output member 92, the driving force output member 92 applies a thrust force to the driving force receiving member 32 in a direction opposite to the mounting direction of the process cartridge C. Under the action of this thrust force, the driving force receiving member 32 can also rotate to the second position. Or in other words, the driving force receiving member 32 rotates under the action of this thrust force to a position that allows the driving force receiving member 32 and the driving force output member 92 to smoothly engage, and the process cartridge C can be smoothly mounted.

Further, when the control member 342 receives the external acting force, the acting portion 3423 also rubs against the driving force receiving member 32, causing the driving force receiving member 32 to rotate by a certain angle, so that the driving force receiving member 32 directly reaches the second position. Then, during the mounting process of the process cartridge C, the driving force receiving member 32 will no longer interfere with the driving force output member 92. That is to say, the driving force receiving member 32 will no longer receive the thrust force. Thus, the process cartridge C can be mounted more smoothly.

When the control member 342 no longer receives the external acting force, the reset member 343 releases the restoring force, and the clutch member 33 returns from the disengaged position to the transmission position. The driving force receiving member 32 and the driving force output member 92 engage with each other. As the driving force output member 92 outputs driving force to the driving force receiving member 32, the driving force is sequentially transmitted through the driving force receiving member 32, the active portion 332 on the clutch member 33, and the driven portion 313 on the hub 31 to the cylinder body 311.

Conversely, when the process cartridge C needs to be dismounted from the apparatus, along the mounting direction, the two positional relationships mentioned above may also appear between the entry opening 3223 and the apparatus-side rotation shaft 921. Obviously, in the case of the second position described above, the driving force receiving member 32 and the driving force output member 92 will be able to smoothly disengage, and correspondingly, the process cartridge C can be smoothly dismounted from the apparatus.

In the case of the first position described above, an external acting force may also be applied to the control member 342 by the user, causing the clutch member 33 to move from the transmission position to the disengaged position. At this time, the driving force receiving member 32 will be able to rotate freely, and the reset member 343 undergoes elastic deformation. Even if the driving force receiving member 32 interferes with the driving force output member 92, the driving force receiving member 32 can rotate to the second position. Or in other words, the driving force receiving member 32 can rotate to a position that allows the driving force receiving member 32 and the driving force output member 92 to smoothly disengage. The process cartridge C can be smoothly dismounted.

When the control member 342 no longer receives the external acting force, the reset member 343 releases the restoring force, and the clutch member 33 returns from the disengaged position to the transmission position again. In this embodiment, the transition of the clutch member 33 between the transmission position and the disengaged position and the rotation of the driving force receiving member by a certain angle are simultaneously controlled by the control mechanism 34. Thus, the structure of the driving force receiving assembly 30 can be further simplified. During the mounting process of the process cartridge C and during the removal process of the process cartridge C, the control mechanism 34 can control the clutch member 33, so that the clutch member 33 transitions from the transmission position to the disengaged position. Thereby, the driving force receiving member 32 can rotate freely to avoid or reduce interference with the driving force output member 92, allowing the driving force receiving member 32 and the driving force output member 92 to smoothly engage or disengage. Correspondingly, the process cartridge C can be smoothly mounted or dismounted.

### Embodiment 2

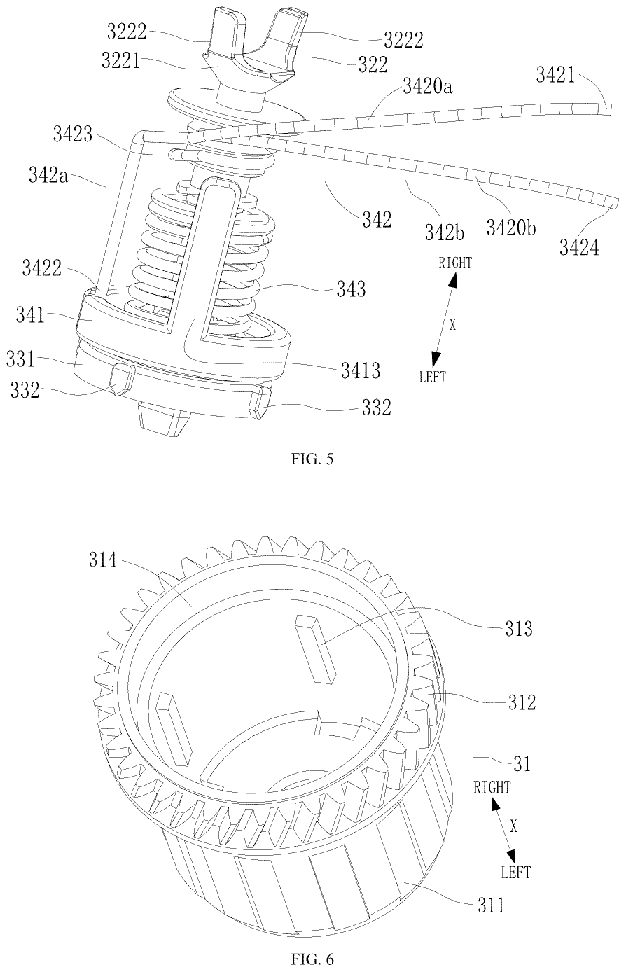

As shown in FIG. 5, the control member 342 in this embodiment includes a first control portion 342a and a second control portion 342b separately formed from the first control portion 342a. Wherein, the first control portion 342a is used to control the movement of the clutch member 33 from the transmission position to the disengaged position, and the second control portion 342b is used to contact the driving force receiving member 32 and generate friction, thereby controlling the rotation of the driving force receiving member 32. Thus, the service life of the first control main body 3420a and the second control main body 3420b can be extended, and the external acting force required by the first control main body 3420a and the external acting force required by the second control main body 3420b can both be reduced.

The first control portion 342a includes a first control main body 3420a, a first end portion 3421, and a second end portion 3422. The first end portion 3421 and the second end portion 3422 are respectively located at two ends of the first control main body 3420a. The second control portion 342b includes a second control main body 3420b, an acting portion 3423, and a third end portion 3424. The acting portion 3423 and the third end portion 3424 are respectively located at two ends of the second control main body 3420b. In this embodiment, the third main body 3420 will include the first control main body 3420a and the second control main body 3420b. Similarly, the acting portion 3423 is used to contact the driving force receiving member 32. When the third end portion 3424 receives an external acting force, a friction force is generated between the acting portion 3423 and the driving force receiving member 32. Under the action of this friction force, the driving force receiving member 32 rotates by a certain angle.

As described above, when the clutch member 33 is in the disengaged position, the driving force receiving member 32 can rotate freely. When the driving force receiving member 32 receives a thrust force from the driving force output member 92, the driving force receiving member 32 will be able to rotate to the second position under the action of the thrust force. Or in other words, the driving force receiving member 32 rotates under the action of the thrust force to a position that allows the driving force receiving member 32 and the driving force output member 92 to smoothly engage. It can be seen that even if the acting portion 3423 does not necessarily interact with the driving force receiving member 32, the driving force receiving member 32 can still smoothly engage with the driving force output member 92. That is to say, the control mechanism 34 is at least used to control the transition of the clutch member 33 between the transmission position and the disengaged position.

Alternatively, when the clutch member 33 is in the disengaged position, if the entry opening 3223 is also located in the first position, before the driving force receiving member 32 and the driving force output member 92 contact each other, the user can also operate the control member 342 (second control portion 342b) to make the driving force receiving member 32 rotate to the second position. In this way, the driving force receiving member 32 and the driving force output member 92 will be able to engage more smoothly.

The control member 342 in this embodiment is configured to include the first control portion 342a and the second control portion 342b. On the one hand, it is beneficial to reduce the external acting force required by each control portion. On the other hand, it can prevent the user from operating the second control portion 342b, causing the driving force receiving member 32 which is originally already in the second position to be driven by the friction force to rotate and reach the first position.

### Embodiment 3

In the above embodiment, before the driving force receiving member 32 engages with the driving force output member 92, the clutch member 33 is in the transmission position. When the control member 342 receives an external acting force, the clutch member 33 is pulled by the control member 342 to move to the right along the longitudinal direction X. The clutch member 33 moves from the transmission position to the disengaged position. The reset member 343 undergoes elastic deformation. The driving force receiving member 32 and the driving force output member 92 can engage smoothly. When the control member 342 no longer receives the external acting force, the reset member 343 releases the restoring force, and the clutch member 33 returns from the disengaged position to the transmission position.

Different from the above embodiment, the transmission position and the disengaged position of the driving force receiving member 32 in this embodiment are changed. Specifically, before the driving force receiving member 32 engages with the driving force output member 92, the clutch member 33 is in the disengaged position. Thus, the driving force receiving member 32 and the driving force output member 92 can engage smoothly. Subsequently, under the action of the external acting force received by the control member 342, the clutch member 33 moves to the right along the longitudinal direction X. The clutch member 33 moves from the disengaged position to the transmission position. The driving force receiving member 32 can transmit the driving force output by the driving force output member 92 to the cylinder body 311.

In this embodiment, to maintain the clutch member 33 in the transmission position, the control member 342 needs to be maintained in a state of receiving the external acting force. For this purpose, a holding mechanism may be provided on the control member 342 or the housing, so that after the control member 342 is pulled directly or through the handle 15 by the user, or pulled by other acting means, it is maintained in the state of receiving the external acting force.

In some embodiments, the external acting force may also come from the door cover of the apparatus. As the door cover closes, the door cover applies the external acting force to the control member 342. When the door cover is closed, the control member 342 is held by the door cover in the state of receiving the external acting force. Thus, the door cover may also be considered as a type of holding mechanism.

As shown in FIG. 6, compared to the position of the driven portion 313 in the cylinder body 311 in the above embodiment, the driven portion 313 in this embodiment will be closer to the right end of the cylinder body 311 in the longitudinal direction X, so that the driven portion 313 can cooperate with the active portion 332 in the clutch member 33 after the clutch member 33 is pulled to the right.

When the control member 342 in this embodiment is configured to be the same as in Embodiment 2, in the state where the clutch member 33 is in the transmission position, it is only necessary to ensure that the first end portion 3421 is maintained in the state of receiving the external acting force, while the second control portion 342b does not need to receive the external acting force. In the state where the clutch member 33 is in the disengaged position, in one implementation, both the first control portion 342a and the second control portion 342b do not need to receive external acting force. Even if the driving force receiving member 32 interferes with the driving force output member 92, since the driving force receiving member 32 can rotate freely, the driving force receiving member 32 can also disengage smoothly with the driving force output member 92. In another implementation, the first control portion 342a does not need to receive external acting force, but the second control portion 342b can receive external acting force, causing the driving force receiving member 32 to rotate by a certain angle to reach the second position.

### Embodiment 4

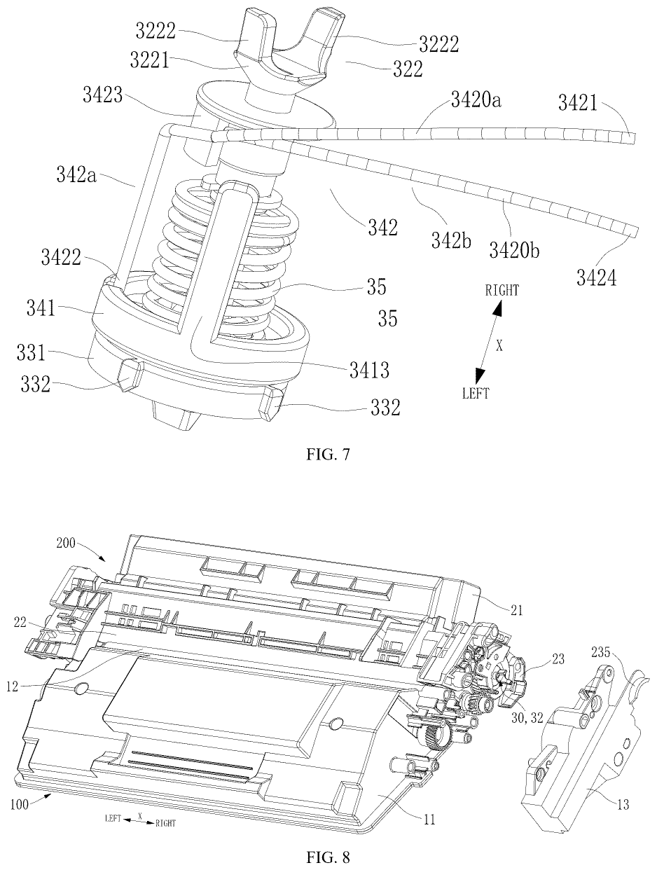

Different from the above embodiment, the acting portion 3423 in this embodiment is configured as a component different from the third main body 3420. As shown in FIG. 7, the acting portion 3423 in this embodiment is configured as a friction member mounted on the third main body 3420 (second control main body 3420b). Compared to the third main body 3420 (second control main body 3420b), the acting portion 3423 has a larger contact area with the driving force receiving member 32. Accordingly, the friction force generated between the acting portion 3423 and the driving force receiving member 32 is also larger. Thus, the driving force receiving member 32 can be driven more easily, or the angle by which the driving force receiving member 32 can rotate is larger.

### Embodiment 5

In existing products, after the process cartridge C is assembled, a part of the plate body 231 will enter the activity cavity 314 (as shown in FIG. 4A and FIG. 4B), so that the hub 31 is supported. At the same time, the bearing plate 23 is further provided with a first protrusion 235. The first protrusion 235 abuts against an apparatus-side positioning portion (such as the acting block 91) in the image forming apparatus, so that the process cartridge C can be positioned in the image forming apparatus. Thus, the first protrusion 235 may also be referred to as a cartridge-side positioned portion disposed in the process cartridge C.

When the driving force receiving member 32 receives driving force, especially at the moment when the driving force receiving member 32 receives the driving force, the large driving force will be transmitted to the plate body 231 via the hub 31, causing the part (the entry portion 238 extending leftward from the plate body 231 as shown in FIG. 4B) of the plate body 231 that enters the activity cavity 314 to be squeezed and deformed by the hub 31, or even broken. The first protrusion 235 abutted by the apparatus-side positioning portion receives a positioning force, which will cause the bearing plate 23 to receive uneven force and lead to overall tilting.

In this embodiment, the first protrusion 235 is no longer disposed on the bearing plate 23, i.e., the first protrusion 235 and the bearing plate 23 are separately provided. As shown in FIG. 8, the first protrusion 235 is formed protruding from the end cover 13. Specifically, along the longitudinal direction X, the first protrusion 235 protrudes from the end cover 13 to the right (direction away from the non-drive end), and the process cartridge C can still achieve positioning by the abutment of the first protrusion 235 with the apparatus-side positioning portion.

As shown in FIG. 2, the first protrusion 235 surrounds at least a part of the driving force receiving member 32. Preferably, when the assembly of the process cartridge C is completed, the first protrusion 235 still surrounds a part of the driving force receiving member 32. For example, the first protrusion 235 is a plate member having an arcuate profile surrounding the rotation axis of the driving force receiving member 32/driving force receiving assembly 30. In some embodiments, the first protrusion 235 may also be formed protruding from the first housing 11, as long as the process cartridge C can be positioned in the image forming apparatus through the abutment of the first protrusion 235 with the apparatus-side positioning portion.

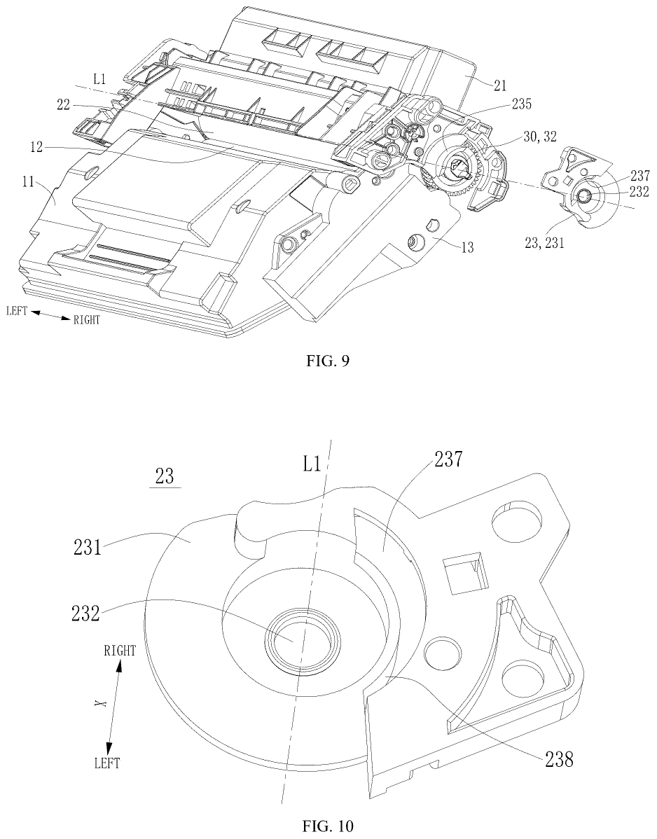

In some embodiments, the first protrusion 235 may also be formed protruding from the second housing 21. As shown in FIG. 9, the first protrusion 235 protrudes rightward from the second housing 21. Preferably, when the assembly of the process cartridge C is completed, the first protrusion 235 still surrounds a part of the driving force receiving member 32. Viewed along the longitudinal direction X, at least a part of the first protrusion 235 overlaps with the plate body 231. The structure of the process cartridge is more compact, facilitating miniaturization. Further, along a direction perpendicular to the rotation axis L1, a part of the first protrusion 235 overlaps with the plate body 231. For example, a through hole 237 (as shown in FIG. 9 and FIG. 10) penetrating the plate body 231 along the longitudinal direction X is provided on the plate body 231. The first protrusion 235 passes through the through hole 237, or a part of the plate body 231 is cut away so that the plate body 231 no longer exists on the side of the first protrusion 235 facing away from the rotation axis L1. That is, the plate body 231 is entirely located on the side of the first protrusion 235 facing the rotation axis L1, and viewed along the longitudinal direction X, the plate body 231 and the first protrusion 235 do not overlap.

According to the above description, the first protrusion 235 in this embodiment may be disposed on at least one of the end cover 13, the first housing 11, and the second housing 21. The instantaneous apparatus acting force received by the bearing plate 23 is alleviated. The stress on the cartridge-side positioned portion is reduced, making it less prone to breakage. At least one of the end cover 13, the first housing 11, and the second housing 21 may be integrally formed with the first protrusion 235, or may be formed separately from the first protrusion 235. When a separate formation method is adopted, at least one of the end cover 13, the first housing 11, and the second housing 21 is detachably coupled to the first protrusion 235. Thus, the user can replace a matching first protrusion 235 according to the structure inside the image forming apparatus, and the process cartridge C will have broader universality.

As described above, the first protrusion 235 in this embodiment is no longer disposed on the bearing plate 23. Therefore, even if the entry portion 238 formed by extending from the plate body 231 deforms, it does not affect the continued abutment of the first protrusion 235 with the apparatus-side positioning portion. Thus, the process cartridge C can still be stably positioned in the image forming apparatus.

### Embodiment 6

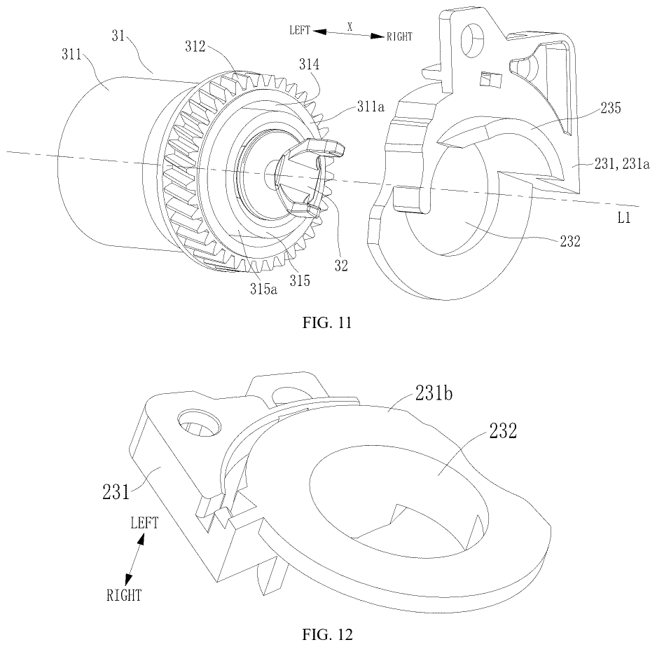

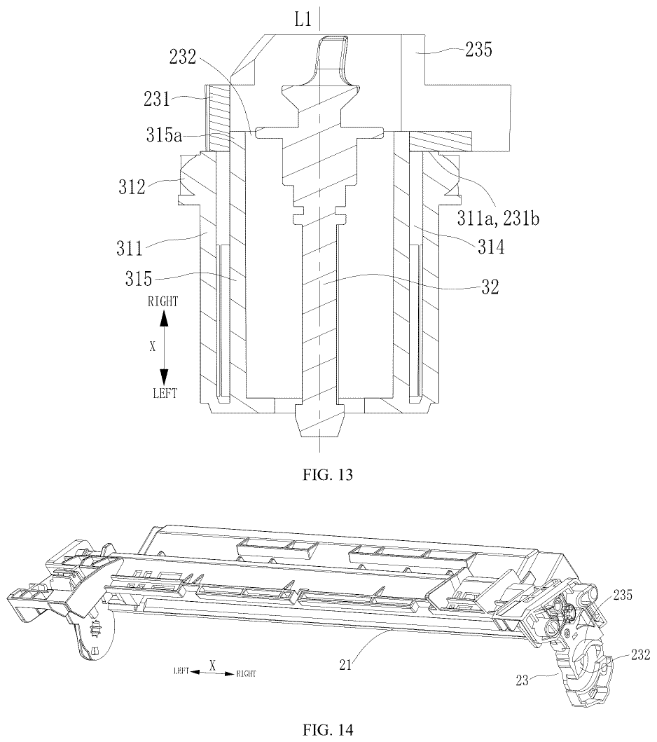

As shown in FIG. 11, FIG. 12, and FIG. 13, different from Embodiment 5, in this embodiment, the first protrusion 235 is still disposed on the plate body 231, but the bearing plate 23 in this embodiment is no longer provided with the entry portion 238. Along the longitudinal direction X, the plate body 231 has a right side surface (outer side surface) 231a and a left side surface (inner side surface) 231b disposed opposite to each other in the left-right direction. In the case where the assembly of the process cartridge C is completed, the right side surface 231a faces right, the left side surface 231b faces left, and the first protrusion 235 protrudes from the right side surface 231a.

Along the longitudinal direction X, the cylinder body 311 has a terminal surface 311a facing the right side. When the assembly of the process cartridge C is completed, the hub 31 is positioned at the right terminal end by the left side surface 231b contacting the terminal surface 311a. Or in other words, the driving force receiving assembly 30 is supported by the bearing plate 23. Even if the driving force receiving member 30 receives a large instantaneous driving force, the bearing plate 23 is not easily squeezed and deformed by the hub 31. The first protrusion 235 also will not tilt due to receiving the positioning force from abutting against the apparatus-side positioning portion. Ultimately, the process cartridge C can be stably positioned in the image forming apparatus.

In some embodiments, the hub 31 further includes an inner cylinder 315 disposed in the activity cavity 314. The inner cylinder 315 is disposed around the circumferential direction of the driving force receiving member 32 and is used to surround at least a part of the driving force receiving member 32. Along the longitudinal direction X, the cylinder body 311 has a terminal surface 311a facing the right side. The inner cylinder 315 has a protruding portion 315a exceeding the terminal surface 311a. When the assembly of the process cartridge C is completed, the bearing plate 23 is sleeved on the radial outer side of the protruding portion 315a through the through hole 232. Along the radial direction of the driving force receiving member 32, the inner surface of the through hole 232 contacts the outer surface of the protruding portion 315a. Compared to the entry portion 238, the plate body 231 has higher strength. Therefore, in this embodiment, even if the hub 31 transmits the large instantaneous driving force received by the driving force receiving member 30 to the plate body 231, the plate body 231 will not easily deform.

In some embodiments, the bearing plate 23 may also be provided with an extension portion formed by extending leftward from the plate body 231. When the assembly of the process cartridge C is completed, observed along the direction of the rotation axis L1, the extension portion is located radially outward of the driving force transmission portion 312. The distance from the extension portion to the rotation axis L1 of the photosensitive drum is greater than the radius of the photosensitive drum. For example, the extension portion may shield at least a part of the driving force transmission portion, and the driving force transmission portion 312 can be protected by the extension portion.

In some embodiments, the first protrusion 235 may also not be disposed on the bearing plate 23, but instead, as described in Embodiment 5, disposed on at least one of the end cover 13, the first housing 11, and the second housing 21.

### Embodiment 7

As shown in FIG. 14, in this embodiment, the first protrusion 235 is also disposed on the second housing 21. Along the longitudinal direction X, the first protrusion 235 is formed protruding rightward from the second housing 21. At the same time, the second housing 21 is also provided with a through hole 232 for allowing the driving force receiving member 32 to pass through. Thus, in this embodiment, it is not necessary to separately provide the bearing plate 23 formed separately from the first housing 11 or the second housing 21. Or in other words, a part of the second housing 21 forms the bearing plate 23, i.e., the bearing plate 23 is integrally formed with the second housing 21.

By such an arrangement, not only can the number of parts and assembly steps of the process cartridge C be reduced, but it also enables the first protrusion 235 to directly transmit the abutting force received from the apparatus-side positioning portion to the second housing 21, effectively preventing the transmission loss of the abutting force caused by manufacturing errors or assembly errors between the bearing plate 23 and the second housing 21.

According to the description of Embodiment 7, when the assembly of the process cartridge C is completed, along the longitudinal direction X, the second housing 21 in this embodiment may also abut against the terminal surface 311a, so that the hub 31 is positioned at the right terminal end.

### Embodiment 8

The side of the process cartridge C provided with the photosensitive drum 22 and the developing roller 12 is defined as the lower side, and the side opposite to the lower side is defined as the upper side. The up-down direction intersects with the front-rear direction and the left-right direction.

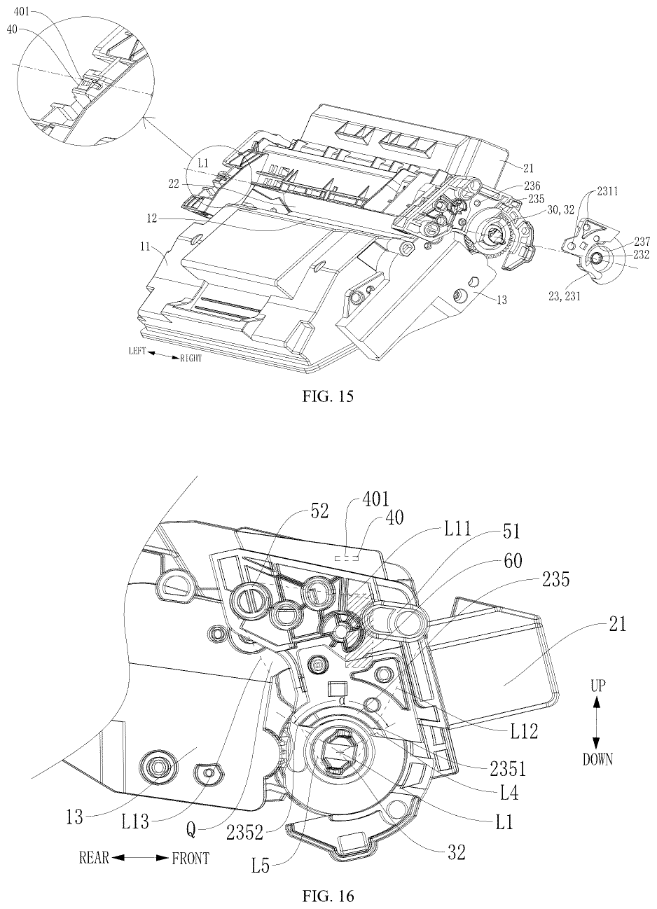

As shown in FIG. 15 and FIG. 16, in this embodiment, the process cartridge C includes a positioning member. The positioning member is used to abut against a guide rail of the image forming apparatus, so that the process cartridge C is guided by the guide rail to a working position. The working position is the position where the process cartridge C is mounted inside the image forming apparatus and the driving force receiving assembly 30 can receive the driving force from the image forming apparatus. The positioning member is disposed at longitudinal end of the housing. The positioning member may be disposed at the drive end and/or the non-drive end of the housing. The positioning member is formed protruding outward along the longitudinal direction X. In this embodiment, the positioning member includes a front positioning member 51 and a rear positioning member 52. The front positioning member 51 and the rear positioning member 52 are spaced apart from each other. In a front-rear direction, the front positioning member 51 is located in front of the rear positioning member 52.

In some embodiments, the cartridge-side positioned portion is formed separately from the bearing plate 23. The cartridge-side positioned portion is connected to at least one of the end cover 13, the first housing 11, and the second housing 21. Specifically, the cartridge-side positioned portion/first protrusion 235 is provided with a positioning connection portion 236. The positioning connection portion 236 is used to connect with at least one of the end cover 13, the first housing 11, and the second housing 21 to fix the cartridge-side positioned portion. In this embodiment, there is at least one positioning connection portion 236. The positioning connection portion 236 is a through hole. By passing a screw through the positioning connection portion 236, the cartridge-side positioned portion is fixedly connected to the second housing 21.

In some embodiments, the positioning connection portion 236 may be connected to at least one of the end cover 13, the first housing 11, and the second housing 21 by a snap-fitting structure, welding, etc.

The bearing plate 23 is provided with a bearing connection portion 2311. The bearing connection portion 2311 is used to connect with at least one of the cartridge-side positioned portion, the end cover 13, the first housing 11, and the second housing 21 to fix the bearing plate 23. Specifically, as shown in FIG. 15, the bearing plate 23 includes a plate body 231. The plate body 231 is provided with a bearing connection portion 2311. The bearing connection portion 2311 is a through hole. By passing a screw through the bearing connection portion 2311, the bearing plate 23 is fixedly connected to the second housing 21.

In some embodiments, the bearing connection portion 2311 and the positioning connection portion 236 are disposed opposite to each other in the longitudinal direction X. By passing a screw simultaneously through the bearing connection portion 2311 and the positioning connection portion 236, the bearing connection portion 2311 and the positioning connection portion 236 are fixed to the second housing 21.

In some embodiments, on a projection plane perpendicular to the longitudinal direction X, at least a part of the projection of the bearing connection portion 2311 and/or at least a part of the projection of the positioning connection portion 236 is located within a maximum area Q enclosed by the front positioning member 51, the rear positioning member 52, and the driving force receiving member 32. The maximum area Q is a closed area bounded collectively by: outer contours of the front positioning member 51, the rear positioning member 52, and the driving force receiving member 53; and straight line segments connecting the front positioning member 51, the rear positioning member 52, and the driving force receiving member 53. Specifically, a first line segment L11 is defined as a straight line segment connecting the front positioning member 51 and the rear positioning member 52. A second line segment L12 is defined as a straight line segment connecting the rear positioning member 52 and the driving force receiving member 32. A third line segment L13 is defined as a straight line segment connecting the driving force receiving member 32 and the front positioning member 51. The maximum area Q is the largest closed area jointly enclosed by these three line segments and the outer contours of the front positioning member 51, the rear positioning member 52, and the driving force receiving member 32.

In some embodiments, as shown in FIG. 16, the non-drive end of the housing is provided with a power receiving portion 60. The power receiving portion 60 is used to electrically contact the image forming apparatus to receive electric power. On the projection plane perpendicular to the longitudinal direction X, at least a part of the projection of the power receiving portion 60 is located within the maximum area Q. By arranging at least a part of the projection of the bearing connection portion 2311 and/or at least a part of the projection of the positioning connection portion 236, and at least a part of the projection of the power receiving portion 60 within the maximum area Q, the process cartridge can be precisely positioned by the apparatus, and the process cartridge can also achieve stable electrical connection with the apparatus.

In some embodiments, the power receiving portion 60 is electrically connected to the photosensitive drum 22 through a charging roller. Specifically, the power receiving portion 60 is electrically connected to the charging roller, and the charging roller is in contact with the surface of the photosensitive drum 22, thereby applying the voltage received by the power receiving portion 60 to the photosensitive drum 22 to charge the photosensitive drum 22.

In some embodiments, the non-drive end of the housing is provided with a chip 40. The chip 40 is disposed at the upper portion of the housing and is disposed along the front-rear direction. The chip 40 has an electrical contact surface 401. The electrical contact surface 401 is used to contact a stylus of the image forming apparatus to form an electrical connection for establishing communication connection. The electrical contact surface 401 faces upward, or in other words, along the up-down direction, the electrical contact surface 401 is disposed facing a direction away from the photosensitive drum. By disposing both the power receiving portion 60 and the chip 40 at the non-drive end of the housing, it is beneficial to reduce vibration interference generated during the rotation of the driving force receiving member; disposing the cartridge-side positioned portion and the driving force receiving assembly 30 at the drive end of the housing is conducive to maintaining a stable working state of the process cartridge.

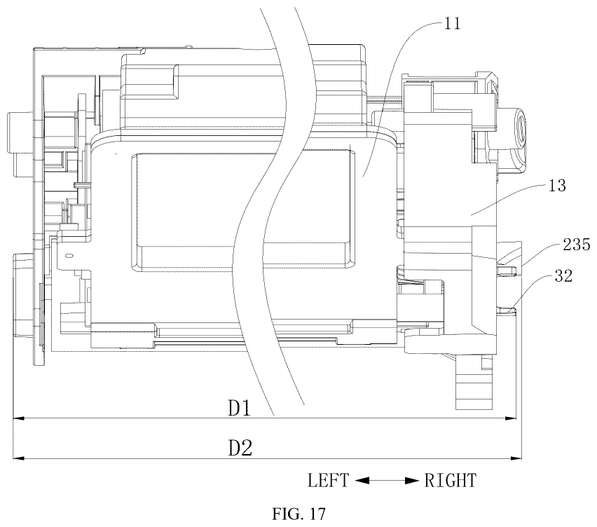

In some embodiments, as shown in FIG. 17, in the longitudinal direction X, the distance from the terminal end of the cartridge-side positioned portion to the non-drive end is greater than or equal to the distance from the terminal end of the driving force receiving member 32 to the non-drive end. During the mounting process of the process cartridge, along the longitudinal direction X, the cartridge-side positioned portion can also avoid interference between the driving force receiving member 32 and the apparatus. Furthermore, the above embodiment configures the cartridge-side positioned portion to surround at least a part of the driving force receiving member 32, which can also prevent the driving force receiving member 32 from interfering with the internal structure of the apparatus and damaging the performance of the driving force receiving assembly 30.

In some embodiments, the first protrusion 235 is provided with a first terminal point 2351 and a second terminal point 2352. The first terminal point 2351 is the point on the first protrusion 235 closest to the front. The second terminal point 2352 is the point on the first protrusion 235 closest to the rear. A line segment connecting the first terminal point 2351 and the rotation axis L1 of the photosensitive drum 22 is defined as a fourth line segment L4. A line segment connecting the second terminal point 2352 and the rotation axis L1 of the photosensitive drum 22 is defined as a fifth line segment L5. An angle α between the fourth line segment L4 and the fifth line segment L5 is 60°<α<180°. Preferably, the angle α is 120°. By defining the specific shape of the cartridge-side positioned portion/first protrusion 235, the cartridge-side positioned portion/first protrusion 235 within the range of the angle α can be guided by the apparatus-side positioning portion, and the process cartridge is easier to detach from the image forming apparatus during the removal process.

What is claimed is:

1. A process cartridge detachably mountable in an image forming apparatus, comprising:
a housing, comprising a first housing for containing toner and a second housing connected to the first housing;
a rotating member, comprising a developing roller rotatably disposed in the first housing and a photosensitive drum rotatably disposed in the second housing, wherein the photosensitive drum is arranged opposite to the developing roller, and the photosensitive drum has a rotation axis extending along a longitudinal direction;
a driving force receiving assembly, located at a drive end of the housing, wherein the driving force receiving assembly comprises a driving force receiving member having a same rotation axis as the photosensitive drum, the force receiving member is configured to receive a driving force from the image forming apparatus;
a bearing plate, configured to support the driving force receiving assembly, wherein the driving force receiving member is exposed outward from the bearing plate; and
a cartridge-side positioned portion, provided separately from the bearing plate and protruding along the longitudinal direction in a direction away from a non-drive end, wherein, when viewed along the longitudinal direction, the cartridge-side positioned portion surrounds a part of the driving force receiving member.

2. The process cartridge according to claim 1, further comprising an end cover disposed on a same side as the driving force receiving assembly, wherein the cartridge-side positioned portion is disposed on at least one of the end cover, the first housing, and the second housing.

3. The process cartridge according to claim 2, wherein the cartridge-side positioned portion is configured as a plate member having an arcuate profile surrounding the rotation axis of the driving force receiving member.

4. The process cartridge according to claim 2, wherein at least one of the end cover, the first housing, and the second housing is detachably coupled to the cartridge-side positioned portion.

5. The process cartridge according to claim 1, wherein the image forming apparatus is provided with an apparatus-side positioning portion, and the process cartridge is positioned in the image forming apparatus by the cartridge-side positioned portion abutting against the apparatus-side positioning portion.

6. The process cartridge according to claim 1, wherein the bearing plate comprises a plate body and a through hole penetrating the plate body, and the driving force receiving member passes through the through hole to be exposed outside the plate body.

7. The process cartridge according to claim 6, wherein when viewed along the longitudinal direction, at least a part of the cartridge-side positioned portion overlaps with the plate body.

8. The process cartridge according to claim 6, wherein the bearing plate comprises an extension portion extending from the plate body in a direction of the non-drive end; when viewed along the longitudinal direction, the extension portion is located radially outward of a driving force transmission portion; and a distance from the extension portion to the rotation axis of the photosensitive drum is greater than a radius of the photosensitive drum.

9. The process cartridge according to claim 1, wherein the image forming apparatus is provided with a driving force output member engaged with the driving force receiving member, the driving force output member comprises an apparatus-side rotation shaft and a force output protrusion protruding from the apparatus-side rotation shaft;
the process cartridge comprises a control mechanism at least for forcing the driving force receiving member to rotate by a certain angle;
the driving force receiving member comprises a plurality of driving force receiving portions, and along a rotation direction of the driving force receiving member, an entry opening allowing the driving force output member to enter is formed between two adjacent driving force receiving portions; and
during mounting and dismounting processes of the process cartridge, the control mechanism is configured to actuate the driving force receiving member to rotate to a position where the entry opening is opposite to the apparatus-side rotation shaft.

10. The process cartridge according to claim 9, wherein the control mechanism comprises an acting portion for contacting the driving force receiving member, and through a friction force generated between the acting portion and the driving force receiving member, the driving force receiving member is driven to rotate by a certain angle.

11. The process cartridge according to claim 1, wherein the non-drive end of the housing is provided with a chip electrically contacting the image forming apparatus, the chip comprises an electrical contact surface for communication connection with the image forming apparatus, the chip is located at an upper portion of the housing, and the electrical contact surface is configured to face upward relative to the housing.

12. The process cartridge according to claim 11, wherein the process cartridge is mounted into and dismounted from the image forming apparatus along a lateral direction, a side of the process cartridge provided with the photosensitive drum and the developing roller is a lower side, a side opposite to the lower side is an upper side, and a direction intersecting with the longitudinal direction and the lateral direction is an up-down direction; and
along the up-down direction, the electrical contact surface is configured to face a direction away from the photosensitive drum.

13. The process cartridge according to claim 12, wherein the image forming apparatus is provided with a guide rail, the process cartridge comprises a positioning member guided by the guide rail, the positioning member protrudes outward from the housing longitudinally; and
along the lateral direction, the positioning member comprises a front positioning member and a rear positioning member which are spaced apart from each other.

14. The process cartridge according to claim 13, wherein the cartridge-side positioned portion comprises a positioning connection portion fixedly connected to at least one of the end cover, the first housing, and the second housing;
the bearing plate comprises a bearing connection portion fixedly connected to at least one of the end cover, the first housing, and the second housing; and
on a plane perpendicular to the longitudinal direction, an orthographic projection of at least one of the bearing connection portion and the positioning connection portion has at least a part that lies within a maximum area bounded by the front positioning member, the rear positioning member, and the driving force receiving member.

15. The process cartridge according to claim 14, wherein the maximum area is a closed area bounded collectively by:
(i) outer contours of the front positioning member, the rear positioning member, and the driving force receiving member; and
(ii) straight line segments connecting the front positioning member, the rear positioning member, and the driving force receiving member.

16. The process cartridge according to claim 15, wherein the line segments comprise:
(i) a first line segment connecting the front positioning member and the rear positioning member;
(ii) a second line segment connecting the rear positioning member and the driving force receiving member; and
(iii) a third line segment connecting the driving force receiving member and the front positioning member.

17. The process cartridge according to claim 14, wherein the non-drive end of the housing is provided with a power receiving portion for electrically contacting the image forming apparatus to receive electric power; and
on the projection plane perpendicular to the longitudinal direction, at least a part of the projection of the power receiving portion is located within the maximum area.

18. The process cartridge according to claim 1, wherein the cartridge-side positioned portion is provided with a first terminal point and a second terminal point; and
an angle α between a fourth line segment connecting the first terminal point to the rotation axis of the photosensitive drum and a fifth line segment connecting the second terminal point to the rotation axis satisfies: 60°<α>180°.

19. The process cartridge according to claim 14, wherein at least one of the positioning connection portion and the bearing connection portion is fixedly disposed on the second housing, and at least one of the positioning connection portion and the bearing connection portion is configured as a through hole.

20. The process cartridge according to claim 1, wherein along the longitudinal direction, a distance from a terminal end of the cartridge-side positioned portion to the non-drive end is not less than a distance from a terminal end of the driving force receiving member to the non-drive end.
